(19) United States
(12) Patent Application Publication
(10) Pub. No.: US 2026/0176440 A1
(43) Pub. Date: Jun. 25, 2026

(54) METHOD FOR SEPARATING MIXTURE OF POLYMERS

(71) Applicant: LOTTE CHEMICAL CORPORATION, Seoul (KR)

(72) Inventors: Seung Hee Kang, Daejeon (KR); Sung Joon Park, Daejeon (KR); Hyung Ki Min, Daejeon (KR); Hyun Gyu Im, Daejeon (KR)

(73) Assignee: LOTTE CHEMICAL CORPORATION, Seoul (KR)

(21) Appl. No.: 19/132,674

(22) PCT Filed: Nov. 28, 2023
(86) PCT No.: PCT/KR2023/019382

§ 371 Date: May 23, 2025

(30) Foreign Application Priority Data
Nov. 29, 2022 (KR) 10-2022-0162867

(51) Int. Cl. C08J 11/08

(52) U.S. Cl. CPC C08J 11/08; C08J 2323/06; C08J 2323/12; C08J 2325/06; C08J 2367/02; C08J 2377/00

(57) ABSTRACT

The present disclosure relates to a method for separating polymer mixtures. According to an embodiment of the present disclosure, the method for separating polymer mixtures can isolate target polymers with high purity from the polymer mixtures. Additionally, because being able to separate the target polymers with high purity from the polymer mixtures, the method according to an embodiment of the present disclosure allows for more accurate measurement of the composition of the target polymers.

### TECHNICAL FIELD

The present disclosure relates to a method for separating a mixture of polymers.

### BACKGROUND ART

Plastic usage is increasing worldwide. However, most of the used plastic (waste plastic) are not recycled but discarded. Most waste plastics are sorted and separated manually and then recycled or discarded. The manual sorting process is so poor and thus a large amount of plastics is not recycled but discarded. Unused waste plastics include various polymers, such as polyethylene terephthalate 110, nylon 120, polystyrene 210, polyethylene 310, and polypropylene 320. Since the waste plastics have low marketability, the waste plastics are mainly landfilled or incinerated. The resulting generation of microplastics and/or toxic materials causes serious environmental pollution.

Chemical recycling technology has been actively researched recently. The chemical recycling technology recycles unused waste plastics into basic chemical products by gasifying or emulsifying the unused waste plastics. The conditions of a separation/decomposition reaction and the composition of a product vary depending on a type of polymer to be separated. Accordingly, the proportion of each polymer in a mixture of polymers (PM, polymer mixture) is a very important factor in determining the direction of research and development of the chemical recycling technology. Therefore, it is first required to conduct accurate information analysis on the composition of polymer components in plastic waste.

However, most information on plastic waste is known only in the amount generated and the like, and there is no information on its composition. Therefore, most studies have been conducted by randomly setting the composition of plastic waste.

A problem that the composition of plastic waste is not well known is because plastic waste contains very many kinds of polymers and impurities. In particular, plastic waste collected in Korea contains a large amount of polymers with composite components and is heavily polluted.

Single-material plastic waste, such as plastic resin identification codes (RIC) 1 to 6, may be recycled into relatively high-quality products. Such plastic waste is also recycled and upcycled.

On the other hand, composite plastic waste, labeled with Other (RIC 7), is recycled as low-grade plastics. The low-grade plastics are used as insulation, septic tanks, building materials, and the like. A representative composite plastic is a packaging bag. The composite plastic is manufactured with 2 to 3 types of films with individual functions such as blocking, adhesive, and preservation and thus is difficult to be recycled. In addition, the composite plastic waste is difficult to be analyzed for its components.

Korean Patent Registration No. 10-0361735 discloses a method for separating and recycling PE, PP, PET, aluminum, etc. from waste of multilayer packaging films. Korean Patent Publication No. 10-2003-0033642 discloses a method for separating/recycling LDPE, LLDPE, and HDPE from waste such as agricultural waste vinyl films and waste vinyl bags, which are mainly composed of PE. Both Patent Documents 1 and 2 use a single solvent, so that it is not suitable for separating mixture of polymers with complex compositions.

### PRIOR ARTS

### Patent Documents

(Patent Document 1) Korean Patent Registration No. 10-0361735 (Feb. 25, 2002)
(Patent Document 2) Korean Patent Publication No. 10-2003-0033642 (May 27, 2003).

### DISCLOSURE

### Technical Problem

A method for separating a mixture of polymers according to one embodiment of the present disclosure is intended to more accurately analyze the composition of the mixture of polymers by separating target polymers from the mixture of polymers with high purity.

### Technical Solution

A method for separating a mixture of polymers of the present disclosure includes: a first step of separating polyethylene terephthalate and nylon from a mixture of polymers including the polyethylene terephthalate, the nylon, polystyrene, polyethylene and polypropylene using 1,1,1,3,3,3-hexafluoroisopropanol; a second step of separating the polystyrene from the residue of the first step using chloroform; and a third step of separating the polyethylene and the polypropylene from the residue of the second step using 1,2,4-trichlorobenzene.

A method for analyzing the composition of a mixture of polymers of the present disclosure includes measuring the contents of the polymers separated by the method.

### Advantageous Effects

According to an embodiment of the present disclosure, the method for separating mixture of polymers can separate target polymers with high purity from the mixture of polymers.

Further, because being able to separate the target polymers from the mixture of polymers with high purity, the method for separating mixture of polymers according to an embodiment of the present disclosure allows for more accurate measurement of the composition of the target polymers.

### DESCRIPTION OF DRAWINGS

FIG. 1 is a schematic diagram of the present disclosure.

### BEST MODE

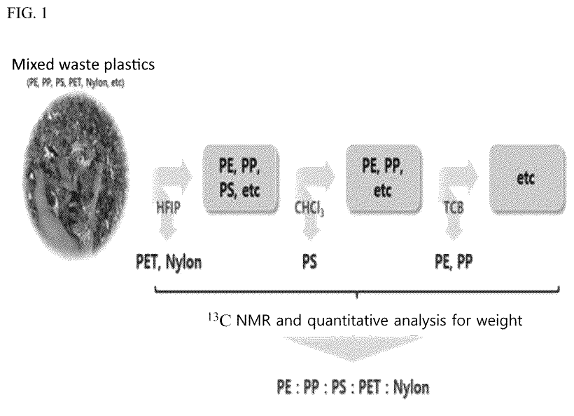

Hereinafter, the present disclosure will be described in detail with reference to FIG. 1.

An aspect of the present disclosure is a method for separating a mixture of polymers.

Specifically, the present disclosure relates to a method for separating target polymers with high purity from a mixture of polymers of a specific composition. More specifically, the present disclosure relates to a method for separating target polymers with high purity from a mixture of polymers of a specific composition using a combination of specific solvents. Much more specifically, the present disclosure relates to a method for separating target polymers with high purity from a mixture of polymers of a specific composition by combining specific solvents in a specific order.

In the present disclosure, a mixture of polymers (PM) of a specific composition is separated. The mixture of polymers (PM) includes polyethylene terephthalate 110, nylon 120, polystyrene 210, polyethylene 310, and polypropylene 320. In the present disclosure, target polymers are separated from the mixture of polymers (PM). The polymers separated in this way are used in the subsequent content measurement process.

The present disclosure uses a solvent having high solubility for some polymers included in the mixture of polymers (PM) and a solvent having low solubility for other polymers. Specifically, only a specific polymer component is dissolved by mixing the mixture of polymers with a specific solvent, and the solvent mixture is filtered to obtain the specific polymer component from the filtrate. The unfiltered residue may be further applied to a subsequent separation process. Through the process, the target polymers may be separated with high purity from the mixture of polymers (PM).

In the present disclosure, specific polymers are separated from the mixture of polymers (PM) using a combination of specific solvents, and at this time, the used order of the solvents is selected. Although described below, in each separation step, a drying process is performed, and at this time, the specific solvents need to be combined in order of decreasing boiling points. The reason is that the solvents used in the previous step do not remain.

In the present disclosure, the polyethylene terephthalate 110 and the nylon 120 are obtained from the 1,1,1,3,3,3-hexafluoroisopropanol 100. The reason is that the polyethylene terephthalate 110 and the nylon 120 in the mixture of polymers (PM) have high solubility in the 1,1,1,3,3,3-hexafluoroisopropanol 100.

In addition, in the present disclosure, the polystyrene 210 is obtained from the chloroform 200. The reason is that the polystyrene 210 in the mixture of polymers (PM) has high solubility in the chloroform 200.

In addition, in the present disclosure, the polyethylene 310 and the polypropylene 320 are obtained from the 1,2,4-trichlorobenzene 300. The reason is that the polyethylene 310 and the polypropylene 320 in the mixture of polymers (PM) have high solubility in the 1,2,4-trichlorobenzene 300.

In addition, the boiling points of the solvents are low in the following order of 58° C. of the 1,1,1,3,3,3-hexafluoroisopropanol 100, 61° C. of the chloroform 200, and 214° C. of the 1,2,4-trichlorobenzene 300. Therefore, in the present disclosure, the separation process is performed in the above order.

Therefore, the present disclosure provides a method for separating a mixture of polymers, including: a first step (S100) of separating polyethylene terephthalate 110 and nylon 120 from a mixture of polymers (PM) including the polyethylene terephthalate 110, the nylon 120, polystyrene 210, polyethylene 310 and polypropylene 320 using 1,1,1,3,3,3-hexafluoroisopropanol 100; a second step (S200) of separating the polystyrene 210 from the residue of the first step (S100) using chloroform 200; and a third step (S300) of separating the polyethylene 310 and the polypropylene 320 from the residue of the second step (S200) using 1,2,4-trichlorobenzene 300.

### First Step (S100)

In the present disclosure, in the first step (S100), the polyethylene terephthalate 110 and the nylon 120 are separated from the mixture of polymers (PM) using the 1,1,1,3,3,3-hexafluoroisopropanol 100. The components separated in this way are results of the first step (S100). The remaining components are a residue of the first step (S100).

When the mixture of polymers (PM) is added to a sufficient amount of 1,1,1,3,3,3-hexafluoroisopropanol 100, the polyethylene terephthalate 110 and the nylon 120 in the mixture of polymers (PM) are dissolved in the 1,1,1,3,3,3-hexafluoroisopropanol 100, and the remaining components are not dissolved in the 1,1,1,3,3,3-hexafluoroisopropanol 100. Thereafter, when the mixture is filtered using a filter, etc., the filtrate contains the polyethylene terephthalate 110 and the nylon 120. The polyethylene terephthalate 110 and the nylon 120 are results of the first step (S100). The remaining undissolved components remain on the filter. These components are referred to as a residue of the first step (S100). This residue is used in the subsequent separation step.

A specific form of mixture of polymers (PM) may be used. For example, the mixture of polymers (PM) may have a size of 5 cm or less. Specifically, it is preferable that the mixture of polymers (PM) has a size of 1 cm or less, if it is not in the form of a film or thread.

The amount of solvent used may be about 1.5 to 2 times greater than the saturation point for the polymer to be analyzed. This is commonly applied to the first step (S100) to the third step (S300).

In the first step (S100), the 1,1,1,3,3,3-hexafluoroisopropanol 100 may be used in the range of 800 parts by weight to 3,200 parts by weight with respect to 100 parts by weight of the mixture of polymers (PM).

The 1,1,1,3,3,3-hexafluoroisopropanol 100 used in the first step (S100) is a material that easily evaporates at room temperature. Therefore, it is preferable that the first step (S100) is performed in a sealed container.

### Second Step (S200)

In the present disclosure, in the second step (S200), the polystyrene 210 is separated from the residue of the first step (S100) using the chloroform 200.

Specifically, in the present disclosure, the polystyrene 210, which is a target polymer, is separated from the residue obtained in the first step, i.e., the mixture of polymers (PM) from which the polyethylene terephthalate 110 and the nylon 120 are separated. More specifically, in the second step (S200) of the present disclosure, the polystyrene 210 is separated from the residue of the first step (S100) using the chloroform 200. More specifically, in the second step (S200) of the present disclosure, the residue of the first step (S100) is added to the chloroform 200 and filtered using a filter or the like. Then, the polystyrene 210 as the result of the second step (S200) is obtained from the filtrate by using a method such as drying. The residue of the second step (S200) remaining after filtration is applied to the subsequent step.

The polystyrene 210 of the residue of the first step (S100) has high solubility in the chloroform 200. Accordingly, when the mixture of the residue of the first step (S100) and the chloroform 200 is filtered, the polystyrene 210 is contained in the filtrate, and the polyethylene 310 and the polypropylene 320 remain in the residue. The former is referred to as a result of the second step (S200), and the latter is referred to as a residue of the second step (S200).

The 1,1,1,3,3,3-hexafluoroisopropanol 100 and the chloroform 200 have high solubility in the polymers to be separated (the former: polyethylene terephthalate 110 and nylon 120, the latter: polystyrene 210) even at room temperature, but the 1,2,4-trichlorobenzene 300 has no high solubility in the polymers. The separation process using the 1,2,4-trichlorobenzene 300 needs to be performed at a temperature of about 160° C. or higher, so that the polyethylene 310 and the polypropylene 320 as the target polymers may be dissolved. Such a high temperature causes deformation or decomposition of the polymers. Therefore, the 1,1,1,3,3,3-hexafluoroisopropanol 100 and the chloroform 200 need to be applied earlier than the 1,2,4-trichlorobenzene 300 to separate the target polymers with high purity.

In addition, the polyethylene terephthalate 110 separated in the first step easily crystallizes when the polyethylene terephthalate 110 comes into contact with the chloroform 200. Accordingly, the separation process using the 1,1,1,3,3,3-hexafluoroisopropanol 100 needs to be performed earlier than the separation process using the chloroform 200.

In the second step (S200), 500 to 2000 parts by weight of the chloroform 200 may be used with respect to 100 parts by weight of the residue of the first step (S100).

The chloroform 200 used in the second step (S200) is also a material that easily evaporates at room temperature like the 1,1,1,3,3,3-hexafluoroisopropanol 100. Therefore, it is preferable that the second step (S200) is performed in a sealed container.

### Third Step (S300)

In the third step (S300) of the present disclosure, the polyethylene 310 and the polypropylene 320 are separated from the residue of the second step (S200) using the 1,2,4-trichlorobenzene 300.

Specifically, in the present disclosure, the polyethylene 310 and the polypropylene 320 as the target polymers are separated from the residue obtained in the second step. More specifically, in the third step (S300) of the present disclosure, the polyethylene 310 and the polypropylene 320 are separated from the residue of the second step (S200) using the 1,2,4-trichlorobenzene 300. More specifically, in the third step (S300) of the present disclosure, the residue of the second step (S200) is added to the 1,2,4-trichlorobenzene 300 and filtered using a filter or the like. Thereafter, the polyethylene 310 and the polypropylene 320 are obtained from the filtrate by using a method such as drying. The polyethylene 310 and the polypropylene 320 are results of the third step (S300). The residue after filtration is applied to the subsequent step.

Unlike the 1,1,1,3,3,3-hexafluoroisopropanol 100 and the chloroform 200, the 1,2,4-trichlorobenzene 300 cannot dissolve the polyethylene 310 and the polypropylene 320 at room temperature. Therefore, it is preferable that the third step (S300) is performed while heated to a predetermined temperature.

Specifically, in the third step (S300), the 1,2,4-trichlorobenzene 300 may be heated to a temperature in the range of 120° C. to 200° C. and then the residue of the second step (S200) may be added to the 1,2,4-trichlorobenzene 300. The third step needs to be performed in the order, so that the residue of the second step (S200) may be well dissolved in the 1,2,4-trichlorobenzene 300.

In the third step (S300), the 1,2,4-trichlorobenzene 300 may be used in the range of 800 to 2,500 parts by weight with respect to 100 parts by weight of the residue of the second step (S200). Such an amount of solvent needs to be used to sufficiently dissolve the solute.

In all of the first step (S100) to third step (S300), the mixed solution is filtered to separate the target polymers. The filter used herein may be, for example, a filter having a pore size in the range of 20 μm to 25 μm. That is, at least one of the first step (S100) to the third step (S300) may be performed using a filter having a pore size in the range of 2.5 μm to 50 μm. Specifically, the pore size of the filter may be in the range of 20 μm to 25 μm. At this time, the filter may be a filter made of a material that is not dissolved in a specific organic solvent, such as paper or glass fiber.

When the weights of the polymers separated through the first step (S100) to the third step (S300) are measured, the content of each polymer component in the mixture of polymers (PM) may be confirmed.

It is expected that other metals or organic materials will be present in the residue of the third step (S300). If necessary, the contents of organic and inorganic materials may be confirmed by ash analysis. Specifically, the content of the organic materials may be determined by ash-analyzing the residue of the third step (S300). When the residue after ash analysis is performed using X-ray fluorescence (XRF), the content of residual element components may also be confirmed.

Another aspect of the present disclosure relates to a method for analyzing the composition of a mixture of polymers. In the present disclosure, the composition of the mixture of polymers is analyzed by separating the mixture of polymers using the above-described method, and measuring the contents of polymers that are separated above.

In particular, the aforementioned mixture of polymers (PM) may also include dyes, metals, additives, etc., in addition to the polymer components described above. Therefore, the composition of the mixture of polymers (PM) needs to be analyzed through additional analysis.

The aforementioned contents may be measured by analyzing the results of each step obtained from the aforementioned separation method. For example, qualitative analysis may be performed using an IR analysis method. In addition, the quantitative analysis may be performed using an NMR analysis method. The NMR analysis method is difficult to quantitatively analyze the mixture when there is no information about the sample. Therefore, it is preferred to measure the aforementioned contents by performing qualitative analysis of the results of each separation step using IR and then quantitative analysis thereof using NMR.

Hereinafter, the contents of the present disclosure will be described in more detail with reference to Examples. However, the scope of the present disclosure is not limited to the following Examples.

### 1. Preparation of Samples

A mixture of polymers (PM) was prepared by mixing 2 g of PET (ICIS unlabeled mineral water, crushed to a size of 1 cm or less) as the polyethylene terephthalate 110, 2 g of Virgin Nylon (Aldrich Nylon 6/12) as the nylon 120, 2 g of Virgin PS (Aldrich Polystyrene Mw to 192,000) as the polystyrene 210, 2 g of Virgin PE (Lotte Chemical FL7100) as the polyethylene 310, and 2 g of Virgin PP (Lotte Chemical J-150) as the polypropylene 320.

### 2. Separation of Mixture of Polymers

### (1) Example 1

### 1) First Step (S100)

A magnetic bar and the mixture of polymers (PM) were added in a wide-mouthed glass bottle. Next, the 1,1,1,3,3,3-hexafluoroisopropanol 100 in an amount 16 times greater than the weight of the mixture of polymers (PM) was added to the glass bottle, sealed, and then stirred at 300 rpm. After 5 days, the mixture was filtered through filter paper with a pore size of 20 to 25 μm. The residue remaining on the filter paper was dried in a 65° C. drying oven and the weight thereof was measured. The contents of the separated polyethylene terephthalate 110 and nylon 120 were calculated using the weight of the dried residue and the amount of solvent used. The dried residue was used in the second step (S200).

### 2) Second Step (S200)

A magnetic bar and the residue of the first step (S100) were added in a wide-mouthed glass bottle. The chloroform 200 in an amount 10 times greater than the weight of the residue of the first step (S100) was added to the glass bottle, sealed, and stirred at 300 rpm. After 3 hours, the mixture was filtered through filter paper with a pore size of 20 to 25 μm. The residue remaining on the filter paper was dried in a 65° C. drying oven and the weight thereof was measured. The content of the separated polystyrene 210 was determined using the weight of the dried residue and the amount of solvent used. The residue remaining on the filter paper was used in the third step (S300).

### 3) Third Step (S300)

A magnetic bar and the 1,2,4-trichlorobenzene 300 in an amount 14.6 times greater than the weight of the residue of the second step (S200) were added in a round bottom flask, stirred at 300 rpm, and heated to 160° C. When the temperature of the 1,2,4-trichlorobenzene 300 reached 160° C., the residue of the second step (S200) was slowly added thereto little by little. The residue of the second step (S200) was fully added and further dissolved for 1 hour. Thereafter, the solution was filtered through filter paper with a pore size of 20 to 25 μm in a flask preheated at a 110° C. drying oven. Next, the residue remaining on the filter paper was washed with acetone, dried in a 110° C. oven, and then the weight thereof was measured. The contents of the polyethylene 310 and the polypropylene 320 separated in the third step (S300) were confirmed using the weight of the dried residue and the amount of solvent used.

### (2) Comparative Example 1

The same process as Example 1 was performed, except that a process of separating the mixture of polymers was performed in the order of the second step (S200), the first step (S100), and the third step (S300).

### (2) Comparative Example 2

The same process as Example 1 was performed, except that a process of separating the mixture of polymers was performed in the order of the third step (S300), the first step (S100), and the second step (S200).

Table 1 showed the results of Example 1, Comparative Example 1, and Comparative Example 2.

TABLE 1

| | Example | Comparative | | Comparative | |
|---|---|---|---|---|---|
| | 1 | Example 1 | | Example 2 | |
| Result of first step | 4.00 g | 4.13 | g¹⁾ | 3.28 | g⁵⁾ |
| Result of second step | 2.00 g | 1.84 | g²⁾ | —⁶⁾ | |
| Result of third step | 4.00 g | 4.00 | g³⁾ | 6.68 | g⁷⁾ |
| Residue | 0 | 0.03 | g⁴⁾ | 0.04 | g⁸⁾ |

Note
The contents of the detected components were the same as the contents of the components that had been added.
¹⁾A small amount of discolored PET remained after reacting with chloroform.
²⁾Transparent PET was discolored and deformed, and the weight was increased, making styrene content measurement results inaccurate
³⁾The contents were matched, but the discolored PET was detected.
⁴⁾Some discolored PET was detected,
⁵⁾Discolored PET and nylon were first removed.
⁶⁾PS was fully dissolved in the previous step and not detected.
⁷⁾Dissolved PE, PP and PS and unidentified polymers were separated. Transparent PET turned white, the shape was also changed, and the weight was also increased. White nylon turned yellow.
⁸⁾TCB was white powder generated during use.

The separation results of the mixture of polymers (PM) were inaccurate if the separation process was not performed in the order of the first step (S100) to the third step (S300).

1. A method for separating a mixture of polymers comprising:
a first step of separating polyethylene terephthalate and nylon from the mixture of polymers including the polyethylene terephthalate, the nylon, polystyrene, polyethylene and polypropylene using 1,1,1,3,3,3-hexafluoroisopropanol;
a second step of separating the polystyrene from a residue of the first step using chloroform; and
a third step of separating the polyethylene and the polypropylene from the residue of the second step using 1,2,4-trichlorobenzene.

2. The method for separating the mixture of polymers of claim 1, wherein in the first step, the 1,1,1,3,3,3-hexafluoroisopropanol is used in the range of 800 parts by weight to 3,200 parts by weight with respect to 100 parts by weight of the mixture of polymers, in the second step, the chloroform is used in the range of 500 parts by weight to 2000 parts by weight with respect to 100 parts by weight of the residue of the first step, and in the third step, the 1,2,4-trichlorobenzene is used in the range of 800 parts by weight to 2,500 parts by weight with respect to 100 parts by weight of the residue of the second step.

3. The method for separating the mixture of polymers of claim 1, wherein at least one of the first step and the second step is performed in a sealed container.

4. The method for separating the mixture of polymers of claim 1, wherein in the third step, the 1,2,4-trichlorobenzene is heated to a temperature in the range of 120° C. to 200° C. and then the residue of the second step is added to the 1,2,4-trichlorobenzene.

5. The method for separating the mixture of polymers of claim 1, wherein at least one of the first step to the third step is performed using a filter having a pore size in the range of 2.5 μm to 50 μm.

6. A method for analyzing the composition of a mixture of polymers, comprising measuring the contents of polymers separated by the method according to claim 1.
